(19) United States
(12) Patent Application Publication
(10) Pub. No.: US 2023/0012269 A1
(43) Pub. Date: Jan. 12, 2023

(54) COMPUTING DEVICE INTERFACE FOR CONFLICT RESOLUTION

(71) Applicant: Wells Fargo Bank, N.A., San Francisco, CA (US)

(72) Inventors: Michelle M. Young, Houston, TX (US); Paul Vittimberga, Oakland, CA (US); Wayne Barakat, Novato, CA (US); David Newman, Walnut Creek, CA (US); Vincent Le Chevalier, San Jose, CA (US); Brian P. McMahon, Berkeley, CA (US)

(21) Appl. No.: 15/807,016

(22) Filed: Nov. 8, 2017

(51) Int. Cl. G06Q 50/18; G06Q 10/10; G10L 15/22; G10L 15/08

(52) U.S. Cl. CPC G06Q 50/182; G06Q 10/103; G10L 15/22; G10L 15/08; G06Q 40/00

(57) ABSTRACT

Various examples describe interfacing at least one computing device to a plurality of human users. An interface system may receive goal data describing a shared goal shared by a plurality of users and transaction data describing a first transaction made by a first user of the plurality of users. The interface system may also receive, from a user computing device, audio data describing speech of the first user and of a second user. The interface system may extract a first word from the audio data and detect a conflict between at least two of the plurality of users based at least in part on the goal data, the transaction data, and the first word. The interface system may further determine a mediation routine for the conflict based at least in part on the goal data, the transaction data, and the first word, and execute the mediation routine.

### TECHNICAL FIELD

Embodiments described herein generally relate to systems and methods for improved interfacing between one or more human users and one or more computing devices.

### BACKGROUND

Human users rely on computing devices to perform a wide variety of tasks, including tasks that until recently would have been completed through direct human-to-human transactions. For example, computing devices are now used to manage financial matters, make reservations for travel or entertainment, make electronic purchases, and control other smart machines, such as thermostats, refrigerators, etc.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a diagram showing one example of an environment for implementing a computing device interface for conflict resolution.

FIG. 2 is a diagram showing another example of the environment of FIG. 1 including additional details.

FIG. 3 is a flowchart showing one example of a process flow that may be executed by the interface system to detect and remediate a conflict among a set of multiple users.

FIG. 4 is a flowchart showing one example of a process flow that may be executed by an interface system to detect a conflict between a set of users.

FIG. 5 is a flowchart showing one example of a process flow that may be executed by an interface system to select a mediation routine for a detected conflict between a set of users.

FIG. 6 is a block diagram showing an example architecture of a user computing device.

FIG. 7 is a block diagram showing one example of a software architecture for a computing device.

FIG. 8 is a block diagram illustrating a computing device hardware architecture, within which a set or sequence of instructions can be executed to cause a machine to perform examples of any one of the methodologies discussed herein.

### DETAILED DESCRIPTION

Various examples are directed to systems and methods for a computing device interface to interface one or more computing devices with a plurality of human users. When multiple users utilize a computing device interface, there is a potential for conflicts between the users about the way that the computing device is or should be used. Various interface examples described herein are arranged to detect and remediate conflicts between multiple users.

In multi-user scenarios, unmediated conflicts between users can lead to inconsistent and inefficient operation of computing devices. For example, a first user may instruct a computing device to perform a first action. A second user may instruct the computing device to reverse the first action and/or to execute a second action inconsistent with the first action. In this way, a computing device and/or system of computing devices operates inefficiently.

To avoid inefficient operation, various examples herein include one or more computing devices that are programmed to detect conflicts between multiple human users and to remediate those conflicts. Detecting and remediating conflicts among human users in this manner may lead to faster, more efficient use of computing resources.

An example interface system may receive goal data describing one or more shared goals held in common by a set of one, two, or more users. Shared goals may be of any suitable type, such as financial goals, business goals, etc. In some examples, a family may have a common financial goal to save for retirement, a child's education, etc. An example of a user business goal could be meeting a periodic budget, meeting a sales goal, etc.

The interface system may also receive transaction data and audio data. Transaction data may describe one or more transactions made by one or more of the users. Transactions may include financial transactions, such as purchases of goods or services, product sales, trades in securities, etc. Audio data may indicate voice data from one or more of the users. Voice data may indicate, for example, voice commands provided by one or more users to the interface system, conversation between the users, etc. The interface system may analyze the audio data to extract additional information such as, for example, word data indicating key words spoken by the users, tone data indicating the users' emotional state, etc.

The interface system may utilize the received data to detect a goal conflict between the set of users. For example, transaction data may indicate that one user is spending at a level that is inconsistent with a financial goal. Also, voice data may include keywords that indicate that one or more users are not in agreement with one or more goals of the group. Voice data may also show that one or more of the users are speaking with raised tones, which may indicate a goal conflict.

In response to detecting a goal conflict, the interface system may select and execute a mediation routine. The mediation routine may prompt the set of users to resolve the goal conflict, for example, by modifying the goal and/or by modifying the behavior of one or more of the set of users that is inconsistent with the goal. In one example mediation routine, the interface system determines a modified goal for the set of users that is consistent with the users' behavior and/or that minimizes the behavioral changes that the users are to make to be consistent with the goal. The interface system may select a mediation routine, for example, based on a type of goal conflict detected. For example, some goal conflicts may arise because one or more of the users do not agree with the goal. Goal conflicts of this type may be remediated, for example, with a mediation routine that takes the user through a process of selecting a new goal that can be agreed to by all or most of the users in the set of users. Another type of goal conflict may arise if one or more users are having difficulty abiding by a goal. Goal conflicts of this type may be remediated, for example, with a mediation routine that is directed to identifying ways for the wayward users to conform to the goal (e.g., by helping the users' budget, by finding savings in one area that would offset excess spending in another area, etc.).

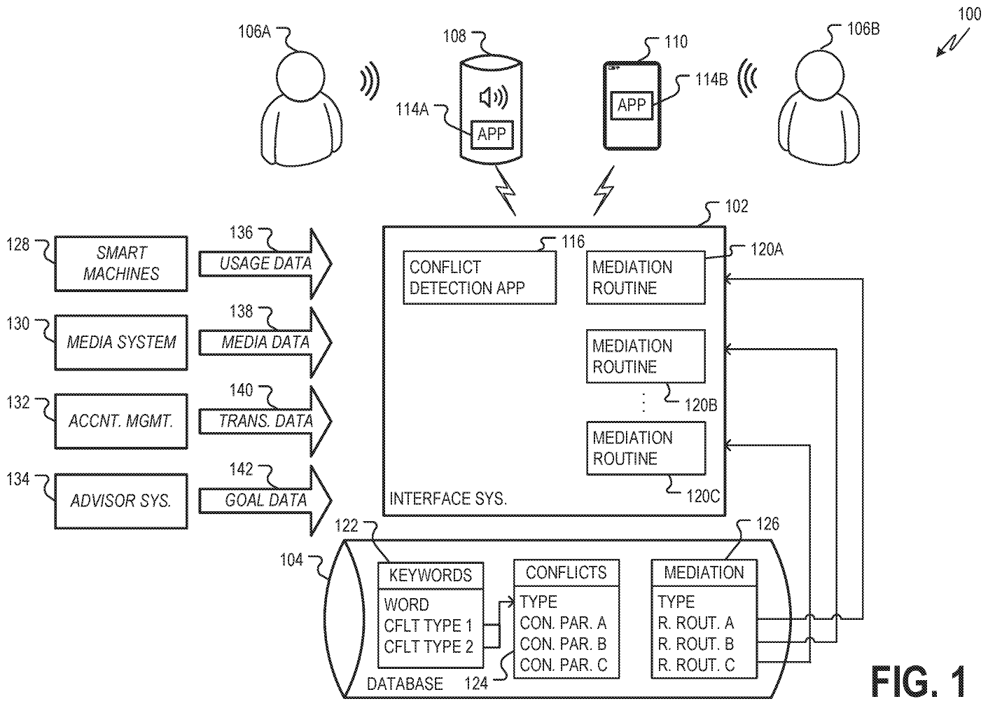

FIG. 1 is a diagram showing one example of an environment 100 for implementing a computing device interface for conflict resolution. The environment 100 comprises an interface system 102. The interface system 102 is in communication with various other computing devices including, for example, user computing devices 108, 110 as well as external systems including, for example, one or more smart machines 128, one or more media systems 130, one or more account management systems 132, and one or more advisor systems 134.

The interface system 102 may be or include any suitable computing device or devices. In some examples, the interface system 102 includes one or more servers or other suitable computing devices. The interface system 102 may be implemented at one or more computing devices at a single location and/or at multiple computing devices distributed over different locations.

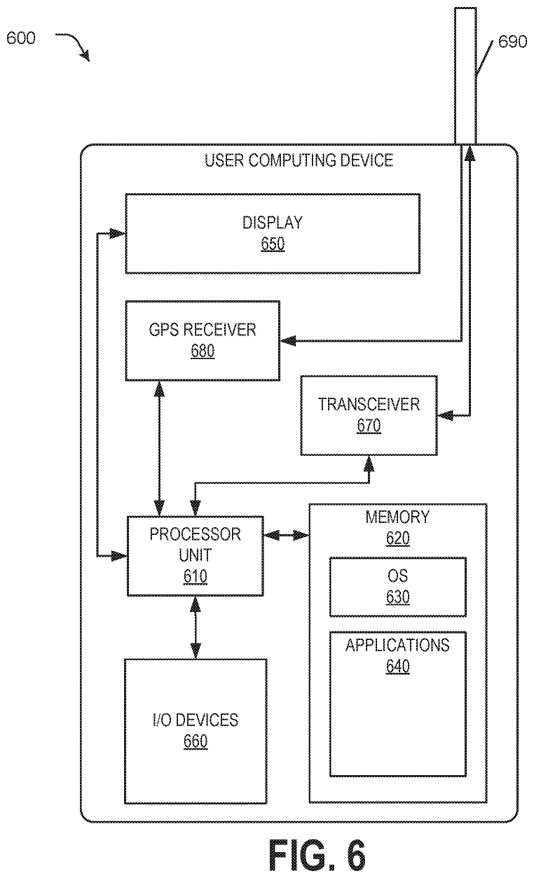

User computing devices 108, 110 may be utilized by users 106A, 106B to access functionality of the environment 100. For example, user computing devices 108, 110 may include one or more mobile telephones, smart speaker devices, tablet computers, laptop computers, desktop computers, etc. User computing devices 108, 110 may be configured with various input/output (I/0) devices for receiving input from and providing output to users 106A, 106B. For example, the user computing devices 108, 110 may include one or more microphones or other audio sensors to receive audio data. For example, audio data may describe the users' speech. User computing devices 108, 110 may also include one or more speakers for providing audio output to the users 106A, 106B. Some user computing devices 108, 110 may also include a display or other output device for providing visual output. Further details of example user computing devices are provided herein with respect to FIG. 6.

In some examples, user computing devices 108, 110 may execute interface applications 114A, 114B. Interface applications 114A, 1148 may provide the users 106A, 106B with access to computer functionality executed at the user computing devices 108, 110, at the interface system 102, and/or at another system. In some examples, interface applications 114A, 114B implement a virtual assistant that provides an audio interface between the user 106A, 106B and one or more computing devices.

Smart machines 128 may include any suitable household or other device that is network-enabled to provide usage data to the interface system 102. Example smart machines 128 in a household setting may include a thermostat, a hot water heater, etc. Example smart machines 128 in a business setting, may include, for example, industrial equipment, a stock or supply dispensing machine, etc. Smart machines 128 may provide the interface system 102 with usage data 136 describing usage of the smart machines 128 by users 106A, 106B. For example, a network-enabled thermostat may provide usage data 136 describing thermostat settings including, in some examples, a user 106A, 106B who initiated a change to the thermostat settings. In another example, a network-enabled Computer Numerical Control (CNC) machine may provide usage data 136 describing the user 106A, 106B who uses the CNC machine as well as a description of the type of work performed (e.g., work pieces used, etc.). In some examples, smart machines may also include one or more machines that measure biometric data of the user 106A, 106B. For example, heart rate, skin temperature, etc. For example, a smart machine may be a wearable computing device worn by a user 106A, 106B, a remote sensor mounted in the user's environment (e.g., on a wall, on an appliance), etc.

One or more media systems 130 may include any system that records communications of the user 106A, 106B, for example, utilizing social media. For example, media systems 130 may include one or more servers from social media providers, such as Facebook, Inc., Twitter, Inc., etc. Media systems 130 may provide media data 138 that may include, for example, social media feeds of one or more of the users 106A, 106B. Biometric parameters may indicate conflict. For example, elevated heart rate, temperature, etc., may indicate that the user 106A, 106B is angry, and therefore indicate a conflict.

One or more account management systems 132 may be associated, for example, with a financial services institution that maintains one or more financial accounts one behalf of a user 106A, 106B and/or a group of users. Financial accounts may include, for example, checking accounts, savings accounts, credit accounts, etc. Account management systems 132 may provide transaction data 140 describing transactions on one or more accounts including, for example, the user 106A, 106B initiating the transactions, an amount of the transactions, etc.

One or more advisor systems 134 may be associated, for example, with a financial advisor or other advisor that, manually or automatically, facilitates the creation of goals for the set of users 106A, 106B. Advisor systems 134 may provide goal data 142 describing one or more goals for the set of users 106A, 106B.

The interface system 102 may execute a conflict detection application 116 that may receive the various data 136, 138, 140, 142 as well as audio and other user input data from the user computing devices 108, 110 and use the data to detect a goal conflict and determine a mediation routine 120A, 120B, 120C for remediating the goal conflict. The conflict detection application 116 may detect a goal conflict, for example, when the actions or words of one or more of the user 106A, 106B is inconsistent with at least one goal, for example, described by goal data 142.

In some examples, the interface system 102 utilizes database processing to detect goal conflicts and identify mediation routines. For example, the interface system 102 may be in communication with a database 104 including data for detecting goal conflicts among users 106A, 106B and selecting a mediation routine 120A, 120B, 120C. For example, the database 104 may include various tables 122, 124, 126 including records. A record, for example, may be stored in a row of a database table. A record may include a location for storing data corresponding to a set of columns. In some examples, each record is capable of storing a value for each column of the database table; however, not all records include a value for each column.

In the example of FIG. 1, the database 104 includes a keywords database table 122, a conflicts database table 124 and a mediation routines database table 126. Records in the keywords database table 122 (e.g., keyword records) may indicate keywords, for example, keywords that may be spoken by the set of users. Keyword records may also include one or more goal conflict types that are associated with the keyword. For example, keywords such as “struggle,” “can't,” “trying,” etc., may be associated with goal conflict types characterized by one or more users who struggle to meet the goal. Also, for example, keywords like “disagree,” “ridiculous,” etc. may be associated with goal conflict types characterized by disagreement among the users about the goal. The keywords database table 122 may include various columns such as a word column and various conflict type columns. The word column may indicate the word associated with a particular record. The various conflict type columns may indicate one or more goal conflict types associated with the keyword. Some keywords may be associated with multiple types of goal conflict. For example, some keyword records may include values at more than one conflict type column.

At conflict type columns, records at the keywords database table 122 may reference corresponding records at the conflicts database table 124. For example, conflict type columns at the keywords database table 122 may include foreign keys referring to records at the conflicts database table 124. The conflicts database table 124 may include records that indicate a conflict type and also one or more conflict parameters indicating other descriptors of the conflict type. For example, a conflicts database table 124 record (a conflict record) may indicating a type of contact and various conflict parameters. The interface system 102 may detect a conflict and/or classify a conflict by testing the conflict parameters indicated at the conflict type database table 124.

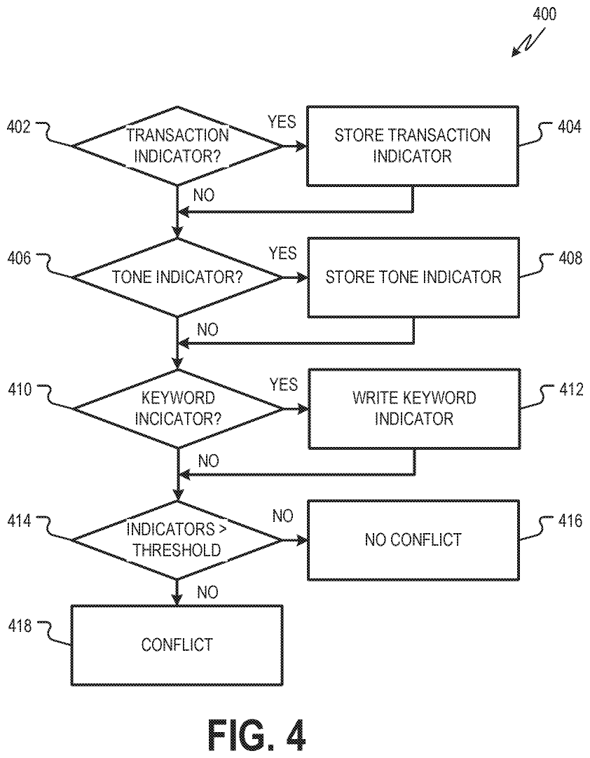

Conflict parameters, in some examples, may refer to other factors that are likely to be present if the indicated conflict type is present. For example, some conflict parameters may refer to other keywords, to transaction goal conflicts, to tone goal conflicts, to biometric data from users 106A, 106B indicative of a conflict, etc., for example, as described herein. Keywords records may be utilized to detect goal conflicts in isolation, or in conjunction with other factors. For example, if all or a sufficient number or portion of the conflict parameters of the conflicts database table 124 are present, the interface system 102 may determine that a conflict exits. Also, in some examples, keyword records may be used as one factor in a multi-factor determination, for example, as described herein with respect to FIG. 4.

A mediation database table 126 may include records for different types of goal conflicts as well as references to one or more mediation routines 120A, 120B, 120C that may be executed to remediate the indicated type of goal conflict. For example, when the interface system 102 detects a goal conflict and classifies the goal conflict as a particular type, it may refer to the mediation database table 126 to find the mediation record corresponding to the conflict type. The mediation record may indicate one or more mediation routines 120A, 120B, 120C that may be suitable for addressing the goal conflict. In some examples, the mediation record may also indicate one or more mediation parameters that the interface system 102 may test to select one or more mediation routines 120A, 120B, 120C to execute. The various tables 122, 124, 126 described herein may have additional columns and/or may omit one or more of the columns shown.

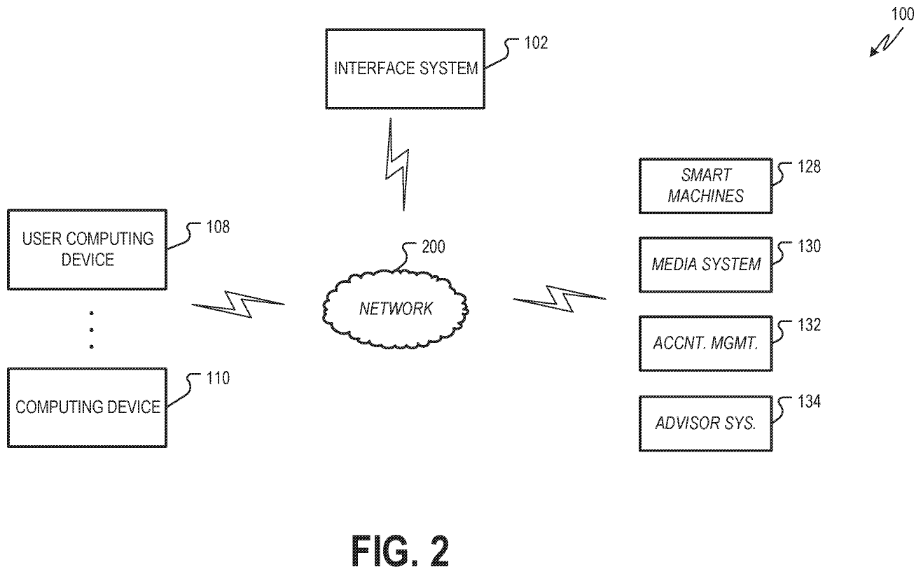

FIG. 2 is a diagram showing another example of the environment 100 including additional details. In the example of FIG. 2, the interface system 102, user computing devices 108, 110, smart machines 128, media systems 130, account management systems 132, and advisor systems 134 are in communication with one another via a network 200. The network 200 may be or comprise any suitable network element operated according to any suitable network protocol. For example, one or more portions of the network 200 may be an ad hoc network, an intranet, an extranet, a virtual private network (VPN), a local-area network (LAN), a wireless LAN (WLAN), a wide-area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, another type of network, or a combination of two or more such networks.

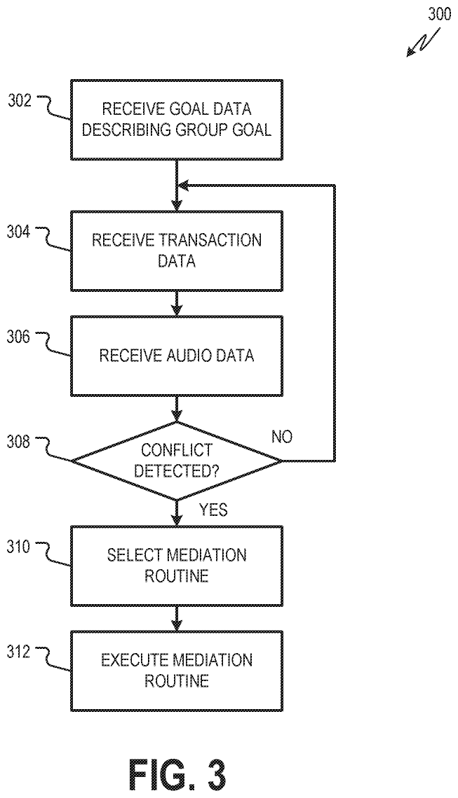

FIG. 3 is a flowchart showing one example of a process flow 300 that may be executed by the interface system, such as the interface system 102, to detect and remediate a goal conflict among a set of multiple users. The process flow 300, in some examples, may be executed in an environment similar to the environment 100, for example, by an interface system similar to the interface system 102. At operation 302, the interface system (e.g., a conflict detection application thereof) may receive goal data describing a goal of the set or group of users. Any suitable goal may be described, including, for example, a goal to save an amount of money for retirement, education, or another purchase for a family, business, department, or other suitable set of users. In another example, the goal may be a budgeting goal for a family, business, department, or other suitable set of users. In yet another example, the goal may be a sales goal for a business, department, or other suitable set of users.

At operation 304, the interface system (e.g., the conflict detection application) may receive transaction data describing one or more transactions made by users of the set of users. Transactions may include, for example, purchase transactions made from checking accounts, credit accounts, etc.; deposit transactions to savings accounts, checking accounts, etc.; payments (e.g., bill payments) from checking accounts, credit accounts, etc.

At operation 306, the interface system (e.g., the conflict detection application 116) may receive audio data. The audio data may be received, directly or indirectly, from a user computing device such as one of user computing devices 108, 110 of FIG. 1. The audio data, in some examples, includes captured voices of one or more of the set of users. In some examples, the interface system extracts one or more keywords from the audio data and identifies one or more keyword records at a keyword database table, such as the database table 122 described herein. Also, in some examples, the interface system may extract tone data from the audio data to determine, for example, if one or more of the set of users has raised their voice. In some examples, the audio data is captured at or near the time of a transaction (e.g., a transaction that conflicts with the goal).

At operation 308, the interface system may determine if a goal conflict is detected. The determination at operation 308 may be based, at least in part, on the transaction data received at operation 304 and on the audio data received at operation 306. In some examples, the determining at operation 308 may also be based on additional data such as, for example, media data described herein. Additional examples describing how a goal conflict may be detected are described herein including, for example, with reference to FIG. 4. If no goal conflict is detected at operation 308, in some examples, the interface system continues to receive transaction data (operation 304) and audio data (operation 306) and continues to determine if a goal conflict is detected at operation 308.

If a goal conflict is detected at operation 308, the interface system may select a mediation routine at operation 310. The mediation routine may be selected, for example, based on the transaction data, audio data, or other suitable data. At operation 312, the interface system may execute the selected mediation routine.

FIG. 4 is a flowchart showing one example of a process flow 400 that may be executed by an interface system, such as the interface system 102, to detect a goal conflict between a set of users. For example, the process flow 400 shows one example way that an interface system may execute the operation 308 of the process flow 300 described herein.

At operation 402, the interface system may determine whether the received data describes one or more transaction conflict indicators. A transaction conflict indicator is an indicator of a goal conflict that is based on one or more transactions. For example, a transaction conflict indicator may occur if one or more transactions described by transaction data deviates from one or more of the goals of the set of users. A transaction may deviate from a goal, for example, if a transaction or sum of a set of transactions is inconsistent with the goal. Depending on the type of goal, a transaction or set of transactions may deviate from the goal when it is too low or too high. For example, if the goal is a budgeted level of spending, a transaction may deviate from the goal if the transaction is above a budgeted amount for the transaction. Also, for example, a set of transactions may deviate from a goal (e.g., for a period of time) if the sum of transactions over a period of time (e.g., a month) exceeds budgeted spending for the period of time; then the set of transactions during the period of time may be a transaction goal conflict. In some examples, a transaction or set of transactions may deviate from a goal when the transaction or set of transactions is too low, for example where a goal is a level of sales, a level of savings, etc.

If a transaction conflict indicator is detected at operation 402, the interface system may write a description of the transaction conflict indicator, for example, to a conflict record. The description may be stored at any suitable data storage including, for example, a table of a database, a memory, etc. In some examples, the interface system may also determine a weighting for one or more determined transaction goal conflicts. The weighting may indicate the severity of the goal conflict. For example, if a transaction or set of transactions exceeds a spending goal by 50%, the transaction conflict indicator may be given a large weight. On the other hand, if the transaction or set of transactions exceeds the spending goal by 1%, the resulting transaction conflict indicator may be given a smaller weight. In some examples, each transaction that is inconsistent with the goal may be considered a separate goal conflict. Accordingly, the interface system may store a number of goal conflicts from the conflict data that are transaction conflict indicators.

After the indication of a transaction conflict is written at operation 404 (and/or if no transaction conflict is detected at operation 402), the interface system may determine if there are one or more tone conflict indicators at operation 406. A tone conflict indicator may occur if the received audio data shows that one or more users is using a raised tone of voice. For example, the interface system may analyze the received audio data to detect raised tones. Raised tones may be detected in any suitable manner. In some examples, the interface system may detect changes in volume. For example, if one user's voice becomes louder by more than a threshold, then a tone conflict may be detected. Also, in some examples, the interface system may detect a change in frequency of a user's voice. For example, if the user's voice becomes more high-pitched, it may be a tone conflict indicator. In some examples, the interface system may assign a weight to detected tone conflict indicators. For example, a higher weight may be assigned to tone conflict indicators involving multiple users with raised voices. If a tone conflict indicator is detected, the interface system may store the indicator, for example, to the conflict record, at operation 406.

If no tone conflict indicator is detected (or after one or more tone conflict indicators are written at operation 408), the interface system may, at operation 410, determine if one or more keyword conflict indicators are detected. A keyword conflict indicator may occur, for example, if the audio data indicates that one or more of the set of users has used a keyword or keywords indicating goal conflict. In some examples, the interface system may utilize a keyword database table and conflict database table, such as the tables 122 and 124, to detect keyword goal conflicts. For example, if a particular word detected in the audio data has a keyword record in the keyword database table, the interface system may determine conflict parameters, either from the keyword database table or from a conflict type database table. The interface system may evaluate the conflict parameters to determine if the indicated goal conflict or type of goal conflict is present. If a keyword conflict indicator is present, the interface system may write a description of the keyword conflict indicator at operation 412.

If no keyword conflict indicator is detected (or after the indication of one or more keyword goal conflicts is written at operation 412), the interface system may, at operation 414, determine if the count of conflict indicators detected at operations 402, 406, and 410 is greater than a threshold. In some examples, the count utilized at operation 414 may be a weighted count. For example, some indicators may be weighted, as described above. Also, in some examples, different categories of indicators may be weighted differently. For example, tone conflict indicators may be weighted higher than keyword conflict indicators. If the count is higher than the threshold, the interface system may determine that there is a goal conflict, at operation 418. If the count is not higher than the threshold, then the interface system may determine that there is no goal conflict at operation 416.

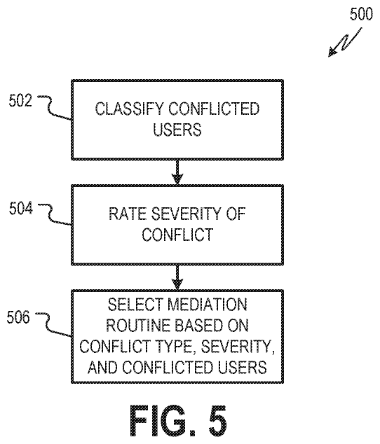

FIG. 5 is a flowchart showing one example of a process flow 500 that may be executed by an interface system, such as the interface system 102, to select a mediation routine for a detected goal conflict between a set of users. For example, the process flow 500 shows one example way that the interface system may perform the operation 310 of the process flow 300 described herein.

At operation 502, the interface system may classify users from the set of users that is in conflict. Classifying the users from set of users may include, for example, determining the positions on the conflict of some or all of the users of the set of users. For example, one or more users who have engaged in transactions that are inconsistent with a group goal may be classified to one position on the goal conflict while one or more users who have not may be classified to another position on the goal conflict. In some examples, users may be classified to different positions of a goal conflict based on keywords and/or tone used by the users. For example, if two years utilize conflict-indicating keywords and/or tone at about the same time, those users may be classified to different sides of the goal conflict.

At operation 504, the interface system may determine a severity of the goal conflict. The severity of the goal conflict may be measured in any suitable manner. Referring to FIG. 4, one example way of determining the severity of the goal conflict may include considering the count and/or weighted count of conflict indicators. For example, the more that the count and/or weighted count of the conflict indicators is greater than the threshold, the more severe the goal conflict may be. Also, in some examples, the interface system may consider individual indicators. For example, if a transaction or set of transactions deviates from a budget by a large margin, it may indicate a severe goal conflict. In another example, the severity of a goal conflict may be determined by considering the classification of the set of users determined at operation 502. For example, if the set of users are closely split (e.g., roughly equal numbers of users on each side), the severity of the goal conflict may be higher.

At operation 506, the interface system may select a mediation routine for the goal conflict. Potential mediation routines may be selected based on, for example, the conflict type, the classifications of the conflicted users, the severity of the goal conflict and, in some examples, conflict indicators. For example, a goal conflict characterized by the use of harsh keywords and tone conflict indicators may select a mediation routine that includes a waiting or “cool-down” period between the time that the mediation routine begins and the time that one or more of the set of users is contacted. Also, in some examples, a goal conflict characterized by having a large majority of the set of users on one side may select a mediation routine that is directed towards mediating the goal conflict by changing the goal that is the source of the goal conflict.

FIG. 6 is a block diagram showing an example architecture 600 of a user computing device. The architecture 600 may, for example, describe any of the computing devices described herein, including, for example, the computing devices 108, 110, 102, 128, 130, 132, 134. The architecture 600 comprises a processor unit 610. The processor unit 610 may include one or more processors. Any of a variety of different types of commercially available processors suitable for computing devices may be used (for example, an XScale architecture microprocessor, a Microprocessor without Interlocked Pipeline Stages (NIPS) architecture processor, or another type of processor). A memory 620, such as a Random Access Memory (RAM), a flash memory, or another type of memory or data storage, is typically accessible to the processor unit 610. The memory 620 may be adapted to store an operating system (OS) 630, as well as application programs 640. In some examples, the memory 620 may also store data describing voices including, for example, data describing a set of known voices, data describing unknown ambient voices that have been indicated at an audio sensor, etc.

The processor unit 610 may be coupled, either directly or via appropriate intermediary hardware, to a display 650 and to one or more input/output (I/O) devices 660, such as a keypad, a touch panel sensor, a microphone, and the like. Such I/O devices 660 may include a touch sensor for capturing fingerprint data, a camera for capturing one or more images of the user, a retinal scanner, or any other suitable devices. The I/O devices 660 may be used to implement I/O channels, as described herein. In some examples, the I/O devices 660 may also include sensors.

Similarly, in some examples, the processor unit 610 may be coupled to a transceiver 670 that interfaces with an antenna 690. The transceiver 670 may be configured to both transmit and receive cellular network signals, wireless data signals, or other types of signals via the antenna 690, depending on the nature of the computing device implemented by the architecture 600. Although one transceiver 670 is shown, in some examples, the architecture 600 includes additional transceivers. For example, a wireless transceiver may be utilized to communicate according to an IEEE 802.11 specification, such as Wi-Fi and/or a short-range communication medium. Some short-range communication mediums, such as NFC, may utilize a separate, dedicated transceiver. Further, in some configurations, a Global Positioning System (GPS) receiver 680 may also make use of the antenna 690 to receive GPS signals. In addition to or instead of the GPS receiver 680, any suitable location-determining sensor may be included and/or used, including, for example, a Wi-Fi positioning system. In some examples, the architecture 600 (e.g., the processor unit 610) may also support a hardware interrupt. In response to a hardware interrupt, the processor unit 610 may pause its processing and execute an interrupt service routine (ISR).

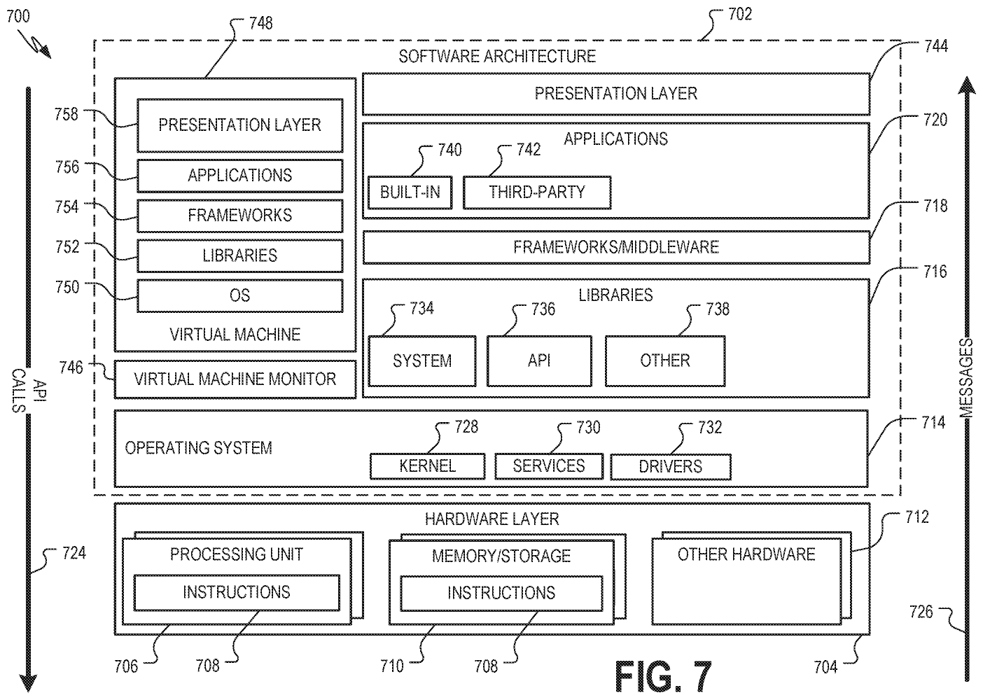

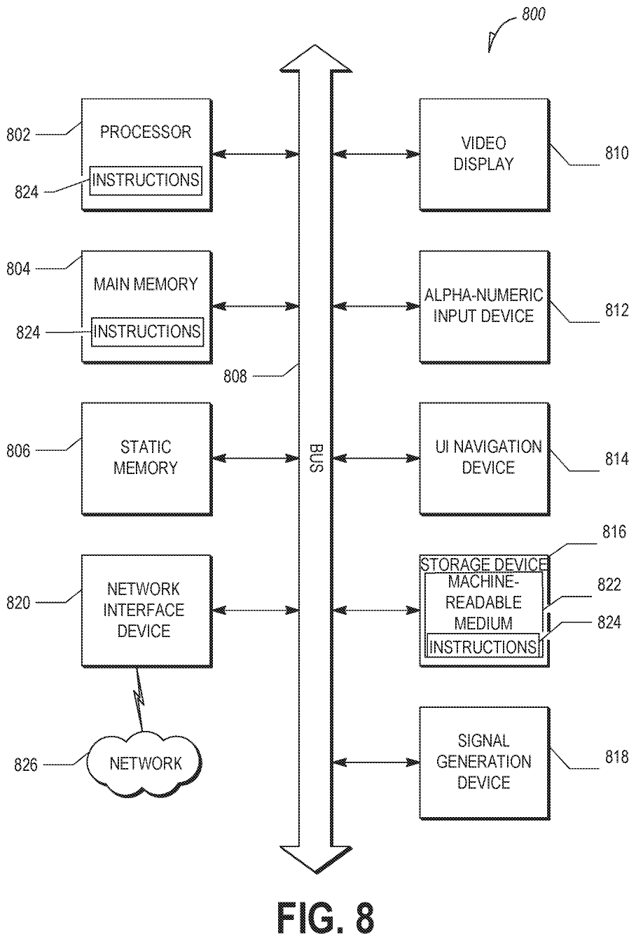

FIG. 7 is a block diagram 700 showing one example of a software architecture 702 for a computing device. The software architecture 702 may be used in conjunction with various hardware architectures, for example, as described herein. FIG. 7 is merely a non-limiting example of a software architecture 702 and many other architectures may be implemented to facilitate the functionality described herein. A representative hardware layer 704 is illustrated and can represent, for example, any of the above-referenced computing devices. In some examples, the hardware layer 704 may be implemented according to an architecture 800 of FIG. 8 and/or the architecture 600 of FIG. 6.

The representative hardware layer 704 comprises one or more processing units 706 having associated executable instructions 708. The executable instructions 708 represent the executable instructions of the software architecture 702, including implementation of the methods, modules, components, and so forth of FIGS. 1-6. The hardware layer 704 also includes memory and/or storage modules 710, which also have the executable instructions 708. The hardware layer 704 may also comprise other hardware 712, which represents any other hardware of the hardware layer 704, such as the other hardware illustrated as part of the architecture 800.

In the example architecture of FIG. 7, the software architecture 702 may be conceptualized as a stack of layers where each layer provides particular functionality. For example, the software architecture 702 may include layers such as an operating system 714, libraries 716, frameworks/middleware 718, applications 720, and a presentation layer 744. Operationally, the applications 720 and/or other components within the layers may invoke API calls 724 through the software stack and receive a response, returned values, and so forth illustrated as messages 726 in response to the API calls 724. The layers illustrated are representative in nature and not all software architectures have all layers. For example, some mobile or special-purpose operating systems may not provide a frameworks/middleware 718 layer, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. In some examples, the services 730 include an interrupt service. The interrupt service may detect the receipt of a hardware or software interrupt and, in response, cause the software architecture 702 to pause its current processing and execute an ISR when an interrupt is received. The ISR may generate an alert.

The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software modules to perform tasks in an easier fashion than by interfacing directly with the underlying operating system 714 functionality (e.g., kernel 728, services 730, and/or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks 718 (also sometimes referred to as middleware) may provide a higher-level common infrastructure that may be utilized by the applications 720 and/or other software components/modules. For example, the frameworks 718 may provide various graphical user interface (GUI) functions, high-level resource management, high-level location services, and so forth. The frameworks 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a contacts application, a browser application, a book reader application, a location application, a media application, a messaging application, and/or a game application. The third-party applications 742 may include any of the built-in applications 740 as well as a broad assortment of other applications. In a specific example, the third-party application 742 (e.g., an application developed using the Android™ or iOST™ software development kit (SDK) by an entity other than the vendor of the particular platform) may be mobile software running on a mobile operating system such as iOS™, Android™, Windows® Phone, or other computing device operating systems. In this example, the third-party application 742 may invoke the API calls 724 provided by the mobile operating system such as the operating system 714 to facilitate functionality described herein.

The applications 720 may utilize built-in operating system functions (e.g., kernel 728, services 730, and/or drivers 732), libraries (e.g., system libraries 734, API libraries 736, and other libraries 738), or frameworks/middleware 718 to create user interfaces to interact with users of the system. Alternatively, or additionally, in some systems, interactions with a user may occur through a presentation layer, such as the presentation layer 744. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 7, this is illustrated by a virtual machine 748. A virtual machine creates a software environment where applications/modules can execute as if they were executing on a hardware computing device. The virtual machine 748 is hosted by a host operating system (e.g., the operating system 714) and typically, although not always, has a virtual machine monitor 746, which manages the operation of the virtual machine 748 as well as the interface with the host operating system (e.g., the operating system 714). A software architecture executes within the virtual machine 748, such as an operating system 750, libraries 752, frameworks/middleware 754, applications 756, and/or a presentation layer 758. These layers of software architecture executing within the virtual machine 748 can be the same as corresponding layers previously described or may be different.

FIG. 8 is a block diagram illustrating a computing device hardware architecture 800, within which a set or sequence of instructions can be executed to cause a machine to perform examples of any one of the methodologies discussed herein. The architecture 800 may describe, for example, any of the computing devices described herein. The architecture 800 may execute the software architecture 702 described with respect to FIG. 7. The architecture 800 may operate as a standalone device or may be connected (e.g., networked) to other machines. In a networked deployment, the architecture 800 may operate in the capacity of either a server or a client machine in server-client network environments, or it may act as a peer machine in peer-to-peer (or distributed) network environments. The architecture 800 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 800 includes a processor unit 802 comprising at least one processor (e.g., a central processing unit (CPU), a graphics processing unit (GPU), or both, processor cores, compute nodes, etc.). The architecture 800 may further comprise a main memory 804 and a static memory 806, which communicate with each other via a link 808 (e.g., bus). The architecture 800 can further include a video display unit 810, an alphanumeric input device 812 (e.g., a keyboard), and a UI navigation device 814 (e.g., a mouse). In some examples, the video display unit 810, alphanumeric input device 812., and UI navigation device 814 are incorporated into a touchscreen display. The architecture 800 may additionally include a storage device 816 (e.g., a drive unit), a signal generation device 818 (e.g., a speaker), a network interface device 820, and one or more sensors (not shown), such as a GPS sensor, compass, accelerometer, or other sensor.

In some examples, the processor unit 802 or another suitable hardware component may support a hardware interrupt. In response to a hardware interrupt, the processor unit 802 may pause its processing and execute an ISR, for example, as described herein.

The storage device 816 includes a machine-readable medium 822 on which is stored one or more sets of data structures and instructions 824 (e.g., software) embodying or utilized by any one or more of the methodologies or functions described herein. The instructions 824 can also reside, completely or at least partially, within the main memory 804, within the static memory 806, and/or within the processor unit 802 during execution thereof by the architecture 800, with the main memory 804, the static memory 806, and the processor unit 802 also constituting machine-readable media. The instructions 824 stored at the machine-readable medium 822 may include, for example, instructions for implementing the software architecture 702, instructions for executing any of the features described herein, etc.

While the machine-readable medium 822 is illustrated in an example to be a single medium, the term “machine-readable medium” can include a single medium or multiple media (e.g., a centralized or distributed database, and/or associated caches and servers) that store the one or more instructions 824. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM) and electrically erasable programmable read-only memory (EEPROM)) and flash memory devices; magnetic disks such as internal hard disks and removable disks; magneto-optical disks; and CD-ROM and DVD-ROM disks.

The instructions 824 can further be transmitted or received over a communications network 826 using a transmission medium via the network interface device 820 utilizing any one of a number of well-known transfer protocols (e.g., hypertext transfer protocol (HTTP)). Examples of communication networks include a LAN, a WAN, the Internet, mobile telephone networks, plain old telephone service (POTS) networks, and wireless data networks (e.g., Wi-Fi, 3G, and 5G LTE/LTE-A or WiMAX networks). The term “transmission medium” shall be taken to include any intangible medium that is capable of storing, encoding, or carrying instructions for execution by the machine, and includes digital or analog communications signals or other intangible media to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

1. An interface system for interfacing at least one computing device to a plurality of human users, the system comprising:
at least one processor unit programmed to execute operations comprising:
receiving goal data describing a shared goal that is shared by a plurality of users;
receiving transaction data describing a number of financial transactions made by a first user of the plurality of users and a number of transactions made by a second user of the plurality of users;
detecting a transaction conflict indicator using the transaction data;
storing the transaction conflict indicator and a weight of the transaction conflict indicator;
receiving, from a user computing device, audio data describing speech of the first user and speech of a second user of the plurality of users;
extracting a first word from the audio data;
detecting a keyword conflict indicator using the first word;
storing the keyword conflict indicator and a weight of the keyword conflict indicator;
determining a weighted count of conflict indicators using the transaction conflict indicator, the weight of the transaction conflict indicator, the keyword conflict indicator, and the weight of the keyword conflict indicator;
receiving usage data from a network-enabled thermostat of the first user;
detecting a conflict between at least two of the plurality of users based at least in part on the goal data, the weighted count of conflict indicators, and the usage data received from a network-enabled thermostat of the first user;
identifying a first record corresponding to the first word at a keyword database table, wherein the first record comprises a first foreign key referring to a first conflict type record of a conflict database table that is associated with a first conflict type and a second foreign key referring to a second conflict type record of the conflict database table associated with a second conflict type;
determining a plurality of first conflict type parameters associated the first conflict type at the first conflict type record;
determining a plurality of second conflict type parameters associated with the second conflict type at the second conflict type record;
determining that the conflict is of the first conflict type based at least in part on the plurality of first conflict type parameters and the plurality of second conflict type parameters, the determining that the conflict is of the first conflict type comprising determining that a number of the plurality of first conflict type parameters that are true is higher than a number of the plurality of second conflict type parameters that are true;
determining that a first set of users of the plurality of users have taken a first position on the conflict;
determining that a second set of users of the plurality of users have taken a second position on the conflict, the second set of users comprising at least two users of the plurality of users;
determining a severity of the conflict using a difference between the first set of users and the second set of users;
determining a mediation routine for the conflict based at least in part on the goal data, the transaction data, the severity of the conflict, and the first conflict type; and
executing the mediation routine, the executing of the mediation routine comprising:
selecting a cool down time period using the determined severity of the conflict;
selecting a potential modified goal; and
after waiting for the cool down time period, sending a mediation communication to one or more of the plurality of users, the mediation routine comprising an indication of the potential modified goal.

2-3. (canceled)

4. The system of claim 1, wherein the at least one processor unit is further programmed to execute operations comprising detecting a voice tone based at least in part on the audio data, wherein detecting the conflict is based at least in part on the voice tone.

5. The system of claim 1, wherein detecting the conflict further comprises:
determining that a first transaction described by the transaction data conflicts with the shared goal;
determining that a first voice tone of the audio data indicates conflict; and
determining that a set of words indicated by the audio data are associated with conflict.

6. The system of claim 1, wherein detecting the conflict further comprises:
determining that a first number of transactions during a first time period conflict with the shared goal;
identifying a second number of times when at least one voice tone from the audio data indicates conflict;
identifying a third number of times that a set of words from the audio data indicates conflict, and
determining that a count based at least in part on the first number, the second number, and the third number is greater than a threshold.

7. The system of claim 1, further comprising:
determining a weight for a first transaction of the first number of transactions based at least in part on the first transaction; and
applying the weight for the first transaction to the first number of transactions.

8. The system of claim 1, wherein determining the mediation routine for the conflict comprises:
classifying the first user to a first position on the conflict;
classifying the second user to a second position on the conflict; and
determining a number of the plurality of users with the first position on the conflict and a number of the plurality of users with the second position on the conflict.

9. The system of claim 1, wherein the determining of the severity of the severity of the conflict also uses the goal data, the transaction data, and the audio data.

10. A method of interfacing a computing device with human users, the method comprising:
receiving, by a computing device comprising at least one processor unit and an associated memory, goal data describing a shared goal that is shared by a plurality of users;
receiving, by the computing device, transaction data describing a number of financial transactions made by a first user of the plurality of users and a number of transactions made by a second user of the plurality of users;
detecting, by the computing device, a transaction conflict indicator using the transaction data;
storing, by the computing device, the transaction conflict indicator and a weight of the transaction conflict indicator;
receiving, by the computing device and from a user computing device, audio data describing speech of the first user and speech of a second user of the plurality of users;
extracting, by the computing device, a first word from the audio data;
detecting, by the computing device, a keyword conflict indicator using the first word;
storing, by the computing device, the keyword conflict indicator and a weight of the keyword conflict indicator;
determining, by the computing device, a weighted count of conflict indicators using the transaction conflict indicator, the weight of the transaction conflict indicator, the keyword conflict indicator, and the weight of the keyword conflict indicator;
receiving usage data from a network-enabled thermostat of the first user;
detecting, by the computing device, a conflict between at least two of the plurality of users based at least in part on the goal data, the weighted count of conflict indicators, and the usage data received from a network-enabled thermostat of the first user;
identifying a first record corresponding to the first word at a keyword database table, wherein the first record comprises a first foreign key referring to a first conflict type record of a conflict database table that is associated with a first conflict type and a second foreign key referring to a second conflict type record of the conflict database table associated with a second conflict type;
determining a plurality of first conflict type parameters associated with the first conflict type at the first conflict type record;
determining a plurality of second conflict type parameters associated with the second conflict type at the second conflict type record;
determining that the conflict is of the first conflict type based at least in part on the plurality of first conflict type parameters and the plurality of second conflict type parameters, the determining that the conflict is of the first conflict type comprising determining that a number of the plurality of first conflict type parameters that are true is higher than a number of the plurality of second conflict type parameters that are true;
determining that a first set of users of the plurality of users have taken a first position on the conflict;
determining that a second set of users of the plurality of users have taken a second position on the conflict, the second set of users comprising at least two users of the plurality of users;
determining a severity of the conflict using a difference between the first set of users and the second set of users;
determining, by the computing device, a mediation routine for the conflict based at least in part on the goal data, the transaction data, the severity of the conflict, and the first conflict type; and
executing, by the computing device, the mediation routine, the executing of the mediation routine comprising:
selecting a cool down time period using the determined severity of the conflict;
selecting a potential modified goal; and
after waiting for the cool down time period, sending a mediation communication to one or more of the plurality of users, the mediation routine comprising an indication of the potential modified goal.

11-12. (canceled)

13. The method of claim 10, further comprising detecting a voice tone based at least in part on the audio data, wherein detecting the conflict is based at least in part on the voice tone.

14. The method of claim 10, wherein detecting the conflict further comprises:
determining that a first transaction described by the transaction data conflicts with the shared goal;
determining that a first voice tone of the audio data indicates conflict; and
determining that a set of words indicated by the audio data are associated with conflict.

15. The method of claim 10, wherein detecting the conflict further comprises:
determining that a first number of transactions during a first time period conflict with the shared goal;
identifying a second number of times when at least one voice tone from the audio data indicates conflict;
identifying a third number of times that a set of words from the audio data indicates conflict; and
determining that a sum based at least in part on the first number, the second number, and the third number is greater than a threshold.

16. The method of claim 10, further comprising:
determining a weight for a first transaction of the first number of transactions based at least in part on the first transaction; and
applying the weight for the first transaction to the first number of transactions.

17. The method of claim 10, wherein determining the mediation routine for conflict comprises:
classifying the first user to a first position on the conflict;
classifying the second user to a second position on the conflict; and
determining a number of the plurality of users with the first position on the conflict and a number of the plurality of users with the second position on the conflict.

18. The method of claim 10, wherein the determining of the severity of the conflict also uses the goal data, the transaction data, and the audio data.

19. A machine-readable medium having instructions thereon that, when executed by at least one computing device, causes the at least one computing device to perform operations comprising:
receiving goal data describing a shared goal shared by a plurality of users;
receiving transaction data describing a first financial transaction made by a first user of the plurality of users and a transaction made by a second user of the plurality of users;
detecting a transaction conflict indicator using the transaction data;
storing the transaction conflict indicator and a weight of the transaction conflict indicator;
receiving, from a user computing device, audio data describing speech of the first user and speech of a second user of the plurality of users;
extracting a first word from the audio data;
detecting a keyword conflict indicator using the first word;
storing the keyword conflict indicator and a weight of the keyword conflict indicator;
determining a weighted count of conflict indicators using the transaction conflict indicator, the weight of the transaction conflict indicator, the keyword conflict indicator, and the weight of the keyword conflict indicator;
receiving usage data from a network-enabled thermostat of the first user;
detecting a conflict between at least two of the plurality of users based at least in part on the goal data, the weighted count of conflict indicators, and the usage data received from a network-enabled thermostat of the first user;
identifying a first record corresponding to the first word at a keyword database table, wherein the first record comprises a first foreign key referring to a first conflict type record of a conflict database table that is associated with a first conflict type and a second foreign key referring to a second conflict type record of the conflict database table associated with a second conflict type;
determining a plurality of first conflict type parameters associated with the first conflict type at the first conflict type record;
determining a plurality of second conflict type parameters associated with the second conflict type at the second conflict type record;
determining that the conflict is of the first conflict type based at least in part on the plurality of first conflict type parameters and the plurality of second conflict type parameters, the determining that the conflict is of the first conflict type comprising determining that a number of the plurality of first conflict type parameters that are true is higher than a number of the plurality of second conflict type parameters that are true;
determining that a first set of users of the plurality of users have taken a first position on the conflict;
determining that a second set of users of the plurality of users have taken a second position on the conflict, the second set of users comprising at least two users of the plurality of users;
determining a severity of the conflict using a difference between the first set of users and the second set of users;
determining a mediation routine for the conflict based at least in part on the goal data, the transaction data, the severity of the conflict, and the first conflict type; and
executing the mediation routine, the executing of the mediation routine comprising:
selecting a cool down time period using the determined severity of the conflict;
selecting a potential modified goal; and
after waiting for the cool down time period, sending a mediation communication to one or more of the plurality of users, the mediation routine comprising an indication of the potential modified goal.

20-21. (canceled)

22. The machine-readable medium of claim 19, the operations further comprising detecting a voice tone based at least in part on the audio data, wherein detecting the conflict is based at least in part on the voice tone.

23. The machine-readable medium of claim 19, wherein detecting the conflict further comprises:
determining that a first transaction described by the transaction data conflicts with the shared goal;
determining that a first voice tone of the audio data indicates conflict; and
determining that a set of words indicated by the audio data are associated with conflict.
